(19) United States
(12) Patent Application Publication
(10) Pub. No.: US 2023/0408890 A1
(43) Pub. Date: Dec. 21, 2023

(54) OPTICAL ELEMENT DRIVING DEVICE, CAMERA MODULE, AND CAMERA-EQUIPPED DEVICE

(71) Applicants: Tomohiko OSAKA, Tokyo (JP); Masayoshi SUGAWARA, Tokyo (JP); Masahiro ISHIKAWA, Tokyo (JP); Shusuke KOJIMA, Tokyo (JP)

(72) Inventors: Tomohiko OSAKA, Tokyo (JP); Masayoshi SUGAWARA, Tokyo (JP); Masahiro ISHIKAWA, Tokyo (JP); Shusuke KOJIMA, Tokyo (JP)

(73) Assignee: MITSUMI ELECTRIC CO., LTD., Tokyo (JP)

(21) Appl. No.: 18/251,257

(22) PCT Filed: Sep. 28, 2021
(86) PCT No.: PCT/JP2021/035636

§ 371 Date: May 1, 2023

Related U.S. Application Data
(60) Provisional application No. 63/109,385, filed on Nov. 4, 2020.

(51) Int. Cl. G03B 13/36; G03B 5/02

(52) U.S. Cl. CPC G03B 13/36; G03B 5/02

(57) ABSTRACT

An optical element driving device includes: a fixed part; a movable part disposed apart from the fixed part; a support part which supports the movable part with respect to the fixed part; and a driving unit which has an ultrasonic motor that converts a vibration motion into a linear motion and a power transmission part that transmits the driving force of the ultrasonic motor to the movable part, and moves the movable Dart with respect to the fixed Dart, wherein the power transmission part has a plate which is in contact with a resonance part of the ultrasonic motor, and a damper material is disposed on a second surface side opposite to a first surface which is in contact with the resonance part in the plate.

### TECHNICAL FIELD

The present invention relates to an optical-element driving device, a camera module, and a camera-mounted device.

### BACKGROUND ART

In general, a small-sized camera module is mounted in mobile terminals, such as smartphones. An optical-element driving device having an autofocus function of automatically performing focusing during capturing of a subject (hereinafter referred to as “Auto Focus (AF) function”) and a shake-correcting function (hereinafter referred to as “Optical Image Stabilization (OIS) function”) for reducing irregularities of an image by correcting shake (vibration) caused during capturing of an image is applied in such a camera module (see e.g., Patent Literature (hereinafter referred to as “PTL”) 1).

The optical-element driving device having the AF and OIS functions is provided with an autofocus driving unit for moving a lens part in the optical-axis direction (hereinafter, the autofocus driving unit is referred to as “AF driving unit”) and a shake-correcting driving unit for moving the lens part in a plane orthogonal to the optical-axis direction (hereinafter, the shake-correcting driving unit is referred to as “OIS driving unit”). In PTL 1, a voice coil motor (VCM) is employed in the AF driving unit and the OIS driving unit.

In recent years, a camera module including a plurality of optical-element driving devices (typically, two optical-element driving devices) has been put into practical use (so-called dual camera). The dual cameras offer various possibilities according to situations where each of the dual cameras is used, such as a possibility that two images at different focal lengths can be captured at the same time, a possibility that a still image and a video image can be captured simultaneously, and the like.

### CITATION LIST

### Patent Literature

PTL 1
Japanese Patent Application Laid-Open No. 2013-210550

PTL 2
WO2015/123787

### SUMMARY OF INVENTION

### Technical Problem

However, the optical-element driving device utilizing the VCM as in PTL 1 is affected by external magnetism. Thus, there is a possibility that high-precision operation is impaired. In particular, in a dual camera in which optical-element driving devices are placed side by side, it is highly likely that magnetic interference occurs between the optical-element driving devices.

Meanwhile, PTL 2 discloses an optical-element driving device in which an ultrasonic motor is applied to an AF driving unit and an OIS driving unit. The optical-element driving device disclosed in PTL 2 is a magnetless device, and is thus capable of reducing the influence of external magnetism. However, its structure is complicated, and it is difficult to reduce the size and height.

In addition, in the optical-element driving device, a driving sound may be generated when a movable part is moved to perform focusing or shake correction, and thus quietness is required.

An object of the present invention is to provide an optical-element driving device, a camera module, and a camera-mounted device capable of achieving a reduction in size and height and improving driving performance and quietness.

### Solution to Problem

An optical-element driving device according to the present invention includes:
a fixing part;
a movable part disposed apart from the fixing part;
a supporting part configured to support the movable part with respect to the fixing part; and
a driving unit including an ultrasonic motor configured to convert a vibrational motion into a linear motion, and a power transmission part configured to transmit a driving force of the ultrasonic motor to the movable part, the driving unit being configured to move the movable part with respect to the fixing part, wherein
the power transmission part includes a plate making contact with a resonant portion of the ultrasonic motor, and
a damper material is disposed on a second surface side of the plate that is opposite a first surface of the plate that makes contact with the resonant portion.

A camera module according to the present invention includes:
the above-described optical-element driving device;
an optical element to be attached to the movable part; and
an image capturing part configured to capture a subject image imaged by the optical element.

A camera-mounted device according to the present invention is an information apparatus or a transporting apparatus, the camera-mounted device including:
the above-described camera module; and
an image processing part configured to process image information obtained by the camera module.

### Advantageous Effects of Invention

According to the present invention, it is possible to reduce the size and height of the optical-element driving device, the camera module, and the camera-mounted device, and to improve the driving performance and quietness.

### BRIEF DESCRIPTION OF DRAWINGS

FIGS. 1A and 1B illustrate a smartphone in which a camera module according to one embodiment of the present invention is mounted;

FIG. 2 is an external perspective view of an external appearance of the camera module;

FIG. 3 is an external perspective view of an optical-element driving device;

FIG. 4 is an external perspective view of the optical-element driving device;

FIG. 5 is an exploded perspective view of the optical-element driving device;

FIG. 6 is an exploded perspective view of the optical-element driving device;

FIG. 7 is a plan view illustrating an interconnection structure of a base;

FIG. 8 is an enlarged view of an OIS biasing member;

FIGS. 9A and 9B are perspective views of an OIS driving unit;

FIG. 10 is an exploded perspective view of OIS movable part;

FIG. 11 is an exploded perspective view of the OIS movable part;

FIG. 12 is an exploded perspective view of the OIS movable part;

FIGS. 13A and 13B are perspective views of an AF driving unit;

FIGS. 14A and 14B are diagrams illustrating a holding structure for holding the AF driving unit;

FIG. 15 is a plan view of the OIS movable part as viewed from the light reception side in the optical-axis direction;

FIGS. 16A and 16B are plan views of an AF movable part and a first stage;

FIGS. 17A and 17B are a cross-sectional view and a longitudinal sectional view of a peripheral portion of AF driving unit 14;

FIGS. 18A and 18B are enlarged views illustrating the placement of an AF supporting part;

FIGS. 19A to 19C are diagrams illustrating driving sound properties of the optical-element driving device; and

FIGS. 20A and 20B illustrate an automobile as a camera-mounted device in which an in-vehicle camera module is mounted.

### DESCRIPTION OF EMBODIMENTS

Hereinafter, embodiments of the present invention will be described in detail with reference to the drawings.

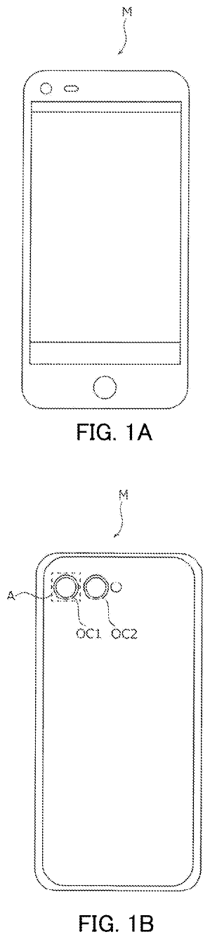

FIGS. 1A and 1B illustrate smartphone M (one example of a camera-mounted device) in which camera module A according to one embodiment of the present invention is mounted.

FIG. 1A is a front view of smartphone M and FIG. 1B is a rear view of smartphone M.

Smartphone M includes a dual camera consisting of two back side cameras OC1 and OC2. In the present embodiment, camera module A is applied to back side cameras OC1 and OC2.

Camera module A has an AF function and an OIS function, and can capture an image without image blurring by automatically performing focusing at the time of capturing a subject and by optically correcting shake (vibration) caused at the time of capturing the image.

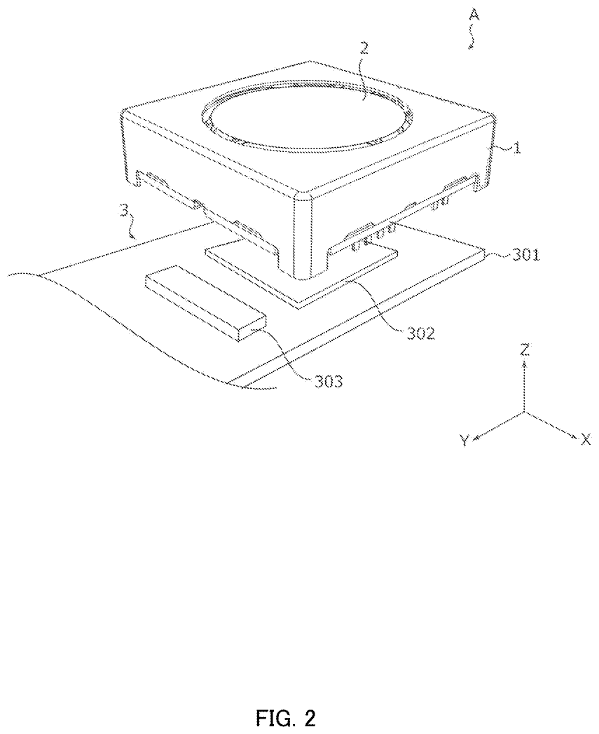

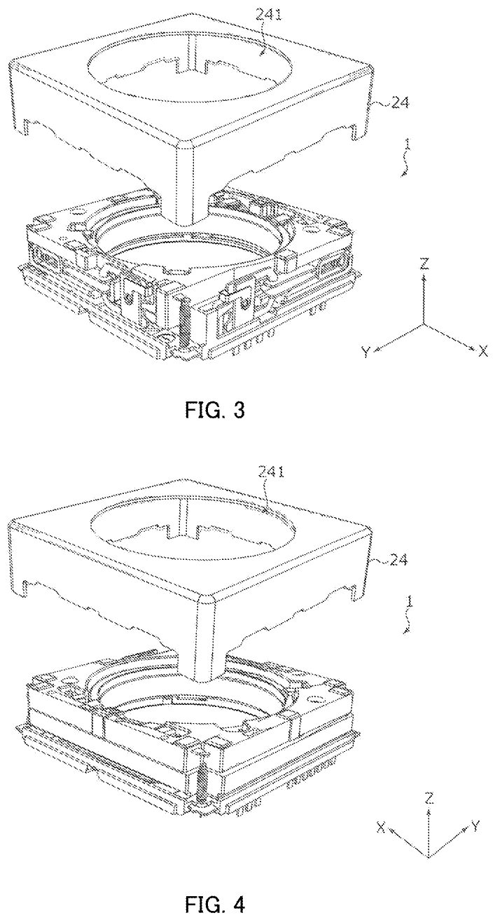

FIG. 2 is an external perspective view of an external appearance of camera module A. FIGS. 3 and 4 are external perspective views of optical-element driving device 1 according to the embodiment. FIG. 4 illustrates the optical-element driving device rotated 180° around the Z-axis from the state of FIG. 3. The embodiment will be described using an orthogonal coordinate system (X, Y, Z) as illustrated in FIGS. 2 to 4. The same orthogonal coordinate system (X, Y, Z) is also used for illustration of below-mentioned figures.

Camera module A is mounted such that the vertical direction (or horizontal direction) is the X-direction, the horizontal direction (or vertical direction) is the Y-direction, and the front-rear direction is the Z-direction, for example, during actually capturing an image with smartphone M. That is, the Z-direction is the optical-axis direction, the upper side (+Z side) in the figures is the light reception side in the optical-axis direction, and the lower side (−Z side) is the image formation side in the optical-axis direction. In addition, the X- and Y-directions orthogonal to the Z-axis are referred to as “optical-axis-orthogonal directions” and the XY plane is referred to as “optical-axis-orthogonal plane.”

As illustrated in FIGS. 2 to 4, camera module A includes: optical-element driving device 1 that implements the AF function and the OIS function; lens part 2 composed of a cylindrical lens barrel and a lens housed therein; image capturing part 3 configured to capture a subject image imaged by lens part 2; and the like. That is, optical-element driving device 1 is a so-called lens driving device that drives lens part 2 as an optical element.

Image capturing part 3 is disposed on the image formation side of optical-element driving device 1 in the optical-axis direction. Image capturing part 3 includes, for example, image sensor board 301, image capturing element 302, and control part 303 mounted on image sensor board 301. Image capturing element 302 is composed of, for example, a Charge-Coupled Device (CCD) image sensor, a Complementary Metal Oxide Semiconductor (CMOS) image sensor, or the like, and captures a subject image imaged by lens part 2. Control part 303 is composed, for example, of a control IC, and performs a drive control of optical-element driving device 1. Optical-element driving device 1 is mounted on image sensor board 301 and is mechanically and electrically connected to the image sensor board. Note that control part 303 may be disposed on image sensor board 301, or may be disposed on a camera-mounted apparatus on which camera module A is mounted (smartphone M in the embodiment).

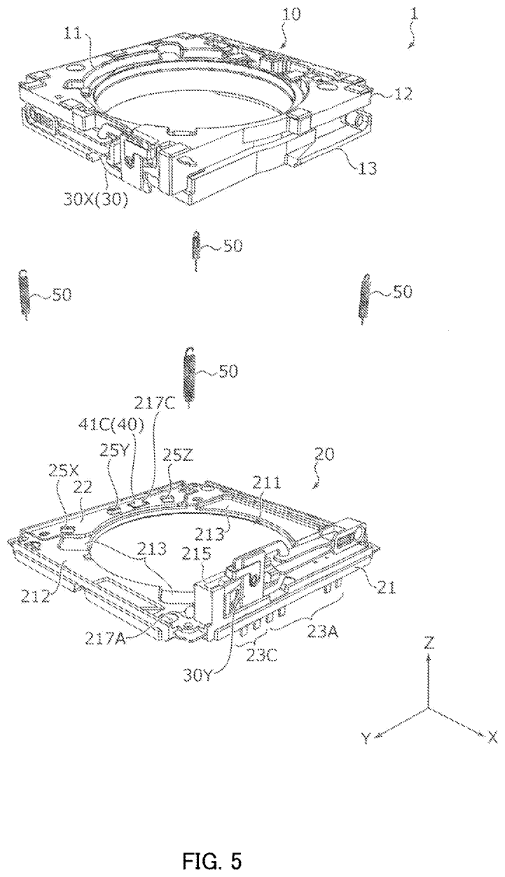

Optical-element driving device 1 is externally covered by cover 24. Cover 24 as seen in plan view in the optical-axis direction is a capped rectangular cylindrical member. In the embodiment, cover 24 as seen in plan view in the optical-axis direction has a square shape. Cover 24 includes, in its upper surface, substantially circular opening 241. Lens part 2 faces the outside via opening 241 of cover 24 and is configured to protrude from an opening surface of cover 24 on the light reception side, for example, with movement in the optical-axis direction. Cover 24 is fixed, for example, adhesively to base 21 (see FIG. 5) of OIS fixing part 20 of optical-element driving device 1.

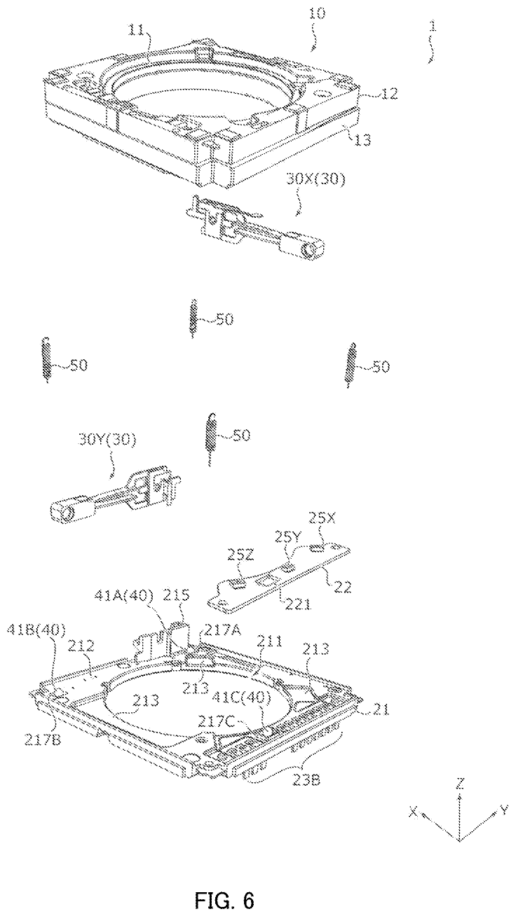

FIGS. 5 and 6 are exploded perspective views of optical-element driving device 1 according to the embodiment. FIG. 6 illustrates the optical-element driving device rotated 180° around the Z-axis from the state of FIG. 5. FIG. 5 illustrates a state in which OIS driving unit 30 and sensor board 22 are attached to base 21, and FIG. 6 illustrates a state in which OIS driving unit 30 and sensor board 22 are detached from base 21.

As illustrated in FIGS. 5 and 6, in the present embodiment, optical-element driving device 1 includes OIS movable part 10, OIS fixing part 20, OIS driving unit 30, and OIS supporting part 40. OIS driving unit 30 includes X-direction driving unit 30X and Y-direction driving unit 30Y

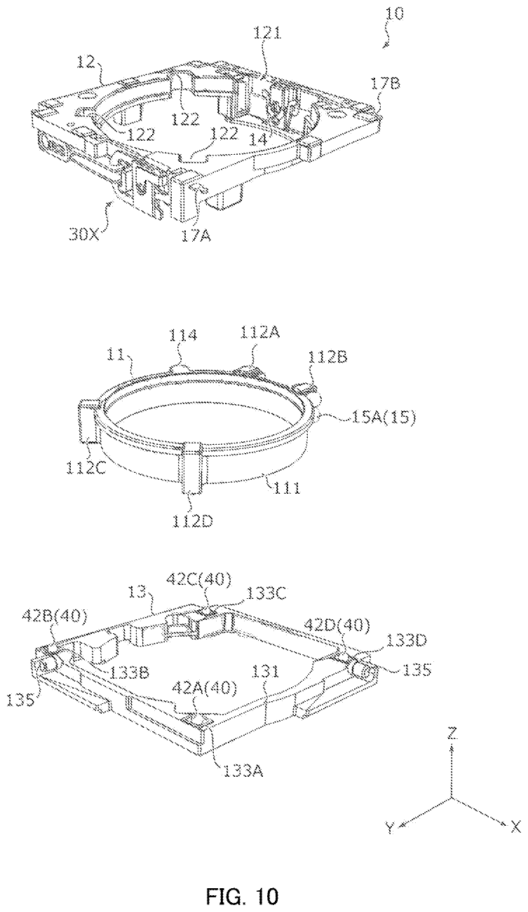

OIS movable part 10 is a part that moves in the optical-axis-orthogonal plane during shake correction. OIS movable part 10 includes an AF unit, second stage 13, and X-direction reference balls 42A to 42D (see FIG. 10 and the like). The AF unit includes AF movable part 11, first stage 12, AF driving unit 14, and AF supporting part 15 (see FIGS. 10 to 12).

OIS fixing part 20 is a part to which OIS movable part 10 is connected via OIS supporting part 40. OIS fixing part 20 includes base 21.

OIS movable part 10 is disposed apart from OIS fixing part 20 in the optical-axis direction, and is coupled to OIS fixing part 20 via OIS supporting part 40. Further, OIS movable part 10 and OIS fixing part 20 are biased in a direction approaching each other by OIS biasing members 50. OIS biasing members 50 are disposed at, for example, four corners of optical-element driving device 1 in plan view.

In the present embodiment, for the movement in the Y-direction, entire OIS movable part 10 including the AF unit moves as a movable body. In addition, for the movement in the X-direction, only the AF unit moves as a movable body. That is, for the movement in the X-direction, second stage 13 together with base 21 constitutes OIS fixing part 20, and X-direction reference balls 42A to 42C function as OIS supporting part 40.

Base 21 is formed of, for example, a molded material made of polyarylate (PAR), a PAR alloy that is a mixture of multiple resin materials containing PAR (e.g., PAR/PC), or a liquid crystal polymer. Base 21 is a rectangular member in plan view, and includes circular opening 211 at the center of base 21.

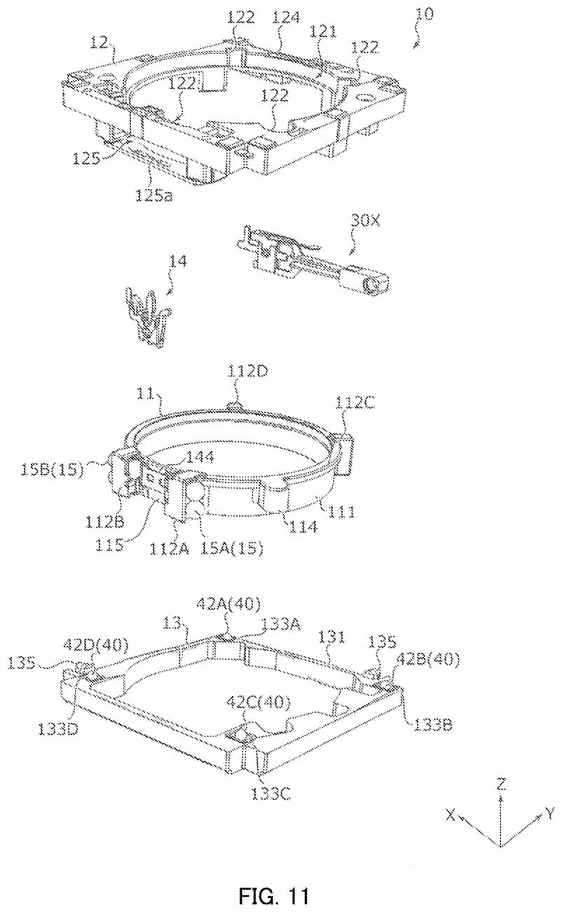

Base 21 includes first base portion 212 and second base portions 213 forming the main surface of base 21. Second base portions 213 are disposed correspondingly to portions of OIS movable part 10 protruding on the image formation side in the optical-axis direction, i.e., protruding portions 112A to 112D of AF movable part 11 and AF motor fixing portion 125 of first stage 12 (see FIG. 11). Second base portions 213 as seen in plan view are formed to be one size larger than protruding portions 112A to 112D and AF motor fixing portion 125, respectively, in order not to cause interference during shake correction. Sensor board 22 is disposed in an area of second base portions 213 where terminal metal fixture 23B is disposed, such that the second base portions are partly exposed. Second base portions 213 are formed to be recessed with respect to first base portion 212, thereby ensuring a movement stroke of AF movable part 11 and achieving reduction of the height of optical-element driving device 1.

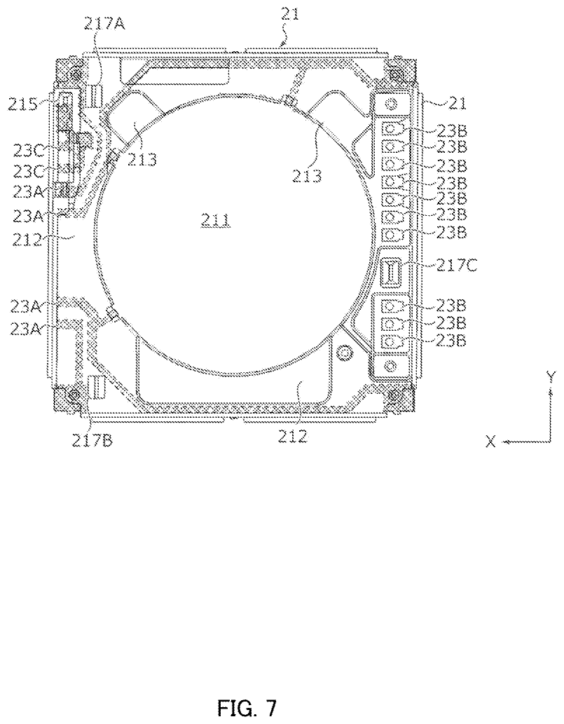

In the present embodiment, sensor board 22 is disposed in a region where AF driving unit 14 and OIS driving unit 30 are not disposed, i.e., in a region corresponding to one side (fourth side) of a rectangle that is a planar shape of base 21. Thus, it is possible to integrate power supply lines and signal lines for magnetic sensors 25X, 25Y, and 25Z, so as to simplify the interconnection structure in base 21 (see FIG. 7).

Base 21 includes OIS motor fixing portion 215 on which Y-direction driving unit 30Y is disposed. OIS motor fixing portion 215 is disposed, for example, at the corner of base 21, is formed to protrude from first base portion 212 toward the light reception side in the optical-axis direction, and has a shape allowing Y-direction driving unit 30Y to be held.

Terminal metal fixtures 23A to 23C are disposed in base 21, for example, by insert molding. Terminal metal fixture 23A includes a power supply line for AF driving unit 14 and X-direction driving unit 30X. For example, terminal metal fixture 23A is exposed at the four corners of base 21 and is electrically connected to OIS biasing members 50. Power supply to AF driving unit 14 and X-direction driving unit 30X is performed via OIS biasing members 50. Terminal metal fixture 23B includes power supply lines (e.g., four power supply lines) for magnetic sensors 25X, 25Y, and 25Z and signal lines (e.g., six signal lines). Terminal metal fixture 23B is electrically connected to interconnections (not illustrated) formed in sensor board 22. Terminal metal fixture 23C includes a power supply line for Y-direction driving unit 30Y

Further, base 21 includes Y-direction reference ball holding portions 217A to 217C in which Y-direction reference balls 41A to 41C constituting OIS supporting part 40 are disposed. Y-direction reference ball holding portions 217A to 217C are formed to be recessed in the shape of a rectangle extending in the Y-direction. Y-direction reference ball holding portions 217A to 217C are formed substantially in a V-shape (tapered shape) in a section such that the groove width tapers toward the bottom side.

In the present embodiment, Y-direction reference ball holding portions 217A and 217B are disposed in the side (third side) of base 21 where Y-direction driving unit 30Y is disposed, and Y-direction reference ball holding portion 217C is disposed in the side (fourth side) where sensor board 22 is disposed. OIS movable part 10 (second stage 13) is supported at three points by Y-direction reference balls 41A to 41C disposed in Y-direction reference ball holding portions 217A to 217C.

Sensor board 22 includes the interconnections (not illustrated) including the power supply lines and the signal lines for magnetic sensors 25X, 25Y, and 25Z. Magnetic sensors 25X, 25Y, and 25Z are mounted on sensor board 22. Magnetic sensors 25X, 25Y, and 25Z are, for example, composed of a Hall element, Tunnel Magneto Resistance (TMR) sensor, or the like, and are electrically connected to terminal metal fixture 23B via the interconnections (not illustrated) formed in sensor board 22. Further, opening 221 is formed in a portion of sensor board 22 corresponding to Y-direction reference ball holding portion 217C.

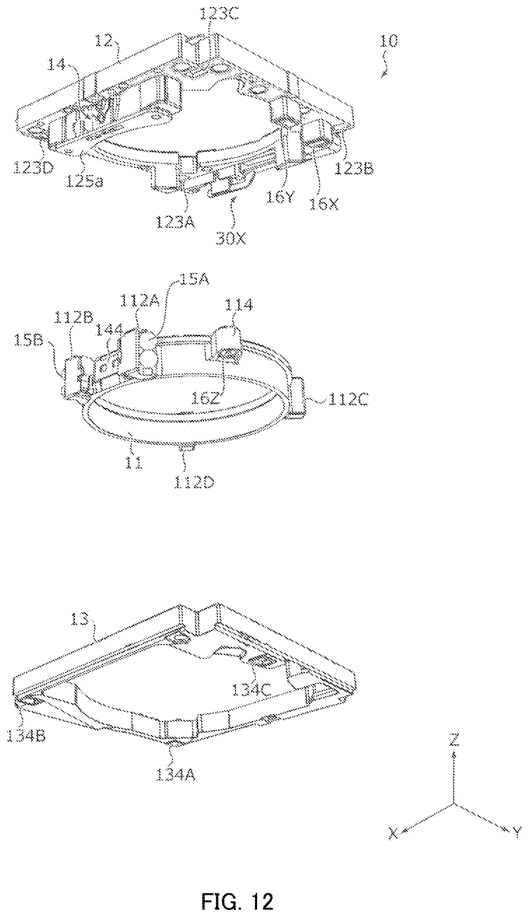

Magnets 16X and 16Y are disposed on first stage 12 of OIS movable part 10 at positions facing magnetic sensors 25X and 25Y (see FIG. 12). Position detecting parts composed of magnetic sensors 25X and 25Y and magnets 16X and 16Y detect the position of OIS movable part 10 in the X- and Y-directions.

Further, magnet 16Z is disposed on AF movable part 11 of OIS movable part 10 at a position facing magnetic sensor 25Z (see FIG. 12). A position detecting part composed of magnetic sensor 25Z and magnet 16Z detects the position of AF movable part 11 in the Z-direction. Note that, in place of magnets 16X, 16Y, and 16Z and magnetic sensors 25X, 25Y, and 25Z, an optical sensor such as a photoreflector may detect the position of OIS movable part 10 in the X- and Y-directions and the position of AF movable part 11 in the Z-direction.

OIS biasing members 50 include, for example, tension coil springs, and couple OIS movable part 10 to OIS fixing part 20. In the present embodiment, one ends of OIS biasing members 50 are connected to terminal metal fixture 23A of base 21, and the other ends are connected to interconnections 17A and 17B of first stage 12. That is, in the present embodiment, OIS biasing members 50 function as power supply lines for AF driving unit 14 and X-direction driving unit 30X.

In addition, OIS biasing members 50 are subjected to a tensile load when OIS movable part 10 is coupled to OIS fixing part 20, and act on OIS movable part 10 and OIS fixing part 20 such that OIS movable part 10 and OIS fixing part 20 approach each other. That is, OIS movable part 10 is held to be movable in the XY plane by OIS biasing members 50 while biased in the optical-axis direction (while pressed against base 21). Thus, it is possible to hold OIS movable part 10 stably without rattling.

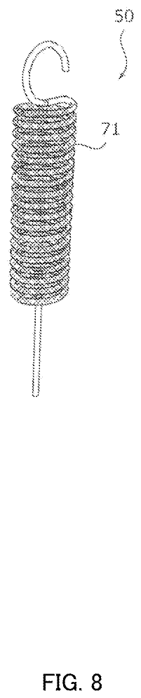

Further, as illustrated in FIG. 8, damper material 71 for suppressing vibrations of OIS biasing members 50 is disposed. Damper material 71 is disposed to entirely cover OIS biasing members 50, for example. An inner hollow portion of each of OIS biasing members 50 is also filled with damper material 71. Damper material 71 is formed, for example, after OIS biasing members 50 are assembled, with the springs being extended. Damper material 71 is formed of a gel-like resin material having a viscosity and elasticity that allow the damper material to remain in the hollow portions of OIS biasing members 50 and that do not impair the followability during movement of OIS movable part 10 in the XY plane. A silicone material, a silicone-based vibration-damping material, or the like can be employed as damper material 71, for example.

Damper material 71 may be disposed to fill only a gap between spring elements adjacent to each other in the axial direction, or may be filled only in the inside of the coil spring.

When OIS biasing members 50 are formed of a spring material, vibration is likely to be generated when OIS movable part 10 moves in the XY plane. This vibration is transmitted through the air and is recognized as a driving sound. In the present embodiment, since damper material 71 is disposed on and/or in OIS biasing members 50, the vibration of OIS biasing members 50 is efficiently damped in a short time, and the aerial vibration caused by the vibration of OIS biasing members 50 is also suppressed. Therefore, the generation of the driving sound can be suppressed, and the noise reduction performance of optical-element driving device 1 is remarkably improved.

OIS supporting part 40 supports OIS movable part 10 with respect to OIS fixing part 20 in a state where OIS movable part 10 is spaced apart from OIS fixing part 20 in the optical-axis direction. In the present embodiment, OIS supporting part 40 includes three Y-direction reference balls 41A to 41C interposed between OIS movable part 10 (second stage 13) and base 21.

Further, OIS supporting part 40 includes four X-direction reference balls 42A to 42D interposed between first stage 12 and second stage 13 in OIS movable part 10 (see FIG. 10 or the like).

In the present embodiment, restricting the directions in which Y-direction reference balls 41A to 41C and X-direction reference balls 42A to 42D (total of seven balls) are rollable allows OIS movable part 10 to move in the XY plane accurately. Note that, the number of Y-direction reference balls and X-direction reference balls constituting OIS supporting part 40 can be appropriately changed.

OIS driving unit 30 is an actuator that moves OIS movable part 10 in the X- and Y-directions. Specifically, OIS driving unit 30 is composed of X-direction driving unit 30X for moving OIS movable part 10 (AF unit alone) in the X-direction, and Y-direction driving unit 30Y for moving entire OIS movable part 10 in the Y-direction.

X-direction driving unit 30X is fixed to OIS motor fixing portion 124 extending along the X-direction of first stage 12 (see FIG. 11). Y-direction driving unit 30Y is fixed to OIS motor fixing portion 215 of base 21 in such a manner as to extend along the Y-direction. That is, X-direction driving unit 30X and Y-direction driving unit 30Y are disposed along the sides orthogonal to each other. X-direction driving unit 30X and Y-direction driving unit 30Y include OIS ultrasonic motor USM1 as described later.

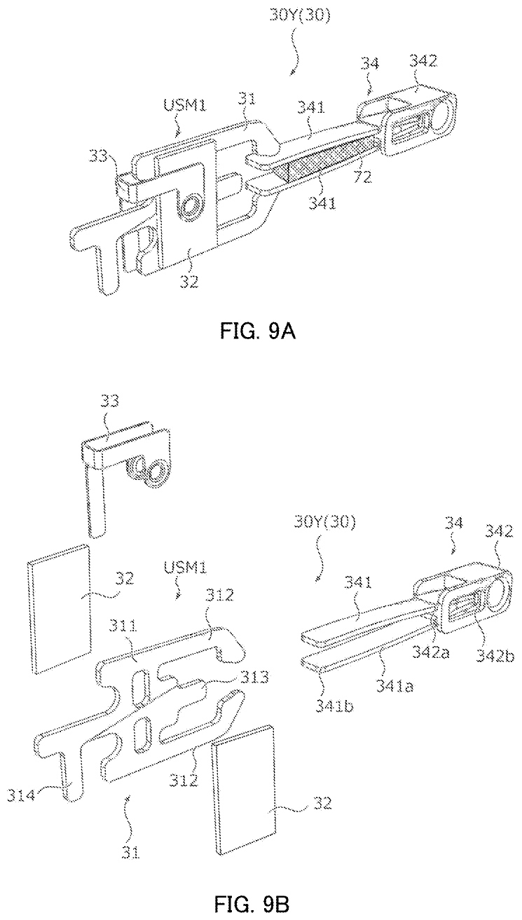

The configuration of OIS driving unit 30 is illustrated in FIGS. 9A and 9B. FIG. 9A illustrates OIS driving unit 30 whose members are assembled, and FIG. 9B illustrates OIS driving unit 30 whose members are disassembled. Note that, although FIGS. 9A and 9B illustrate Y-direction driving unit 30Y, the illustrations are treated as illustrations of OIS driving unit 30 since the principal configuration of X-direction driving unit 30X, specifically, the configuration excluding the shape of OIS electrode 33, is the same as that of Y-direction driving unit 30Y.

As illustrated in FIGS. 9A and 9B, OIS driving unit 30 includes OIS ultrasonic motor USM1 and power transmission part 34. OIS ultrasonic motor USM1 includes OIS resonant portion 31, OIS piezoelectric elements 32, and OIS electrode 33. The driving force of OIS ultrasonic motor USM1 is transmitted to second stage 13 via OIS power transmission part 34. Specifically, X-direction driving unit 30X is connected to second stage 13 via OIS power transmission part 34, and Y-direction driving unit 30Y is connected to second stage 13 via OIS power transmission part 34. That is, in OIS driving unit 30, OIS resonant portion 31 is an active element, and OIS power transmission part 34 is a passive element.

OIS piezoelectric elements 32 are, for example, plate-shaped elements formed of a ceramic material, and generate a vibration under high-frequency voltage application. Two OIS piezoelectric elements 32 are disposed to sandwich body portion 311 of OIS resonant portion 31.

OIS electrode 33 holds OIS resonant portion 31 and OIS piezoelectric elements 32 in between, and applies a voltage to OIS piezoelectric elements 32. OIS electrode 33 of X-direction driving unit 30X is electrically connected to interconnection 17A of first stage 12, and OIS electrode 33 of Y-direction driving unit 30Y is electrically connected to terminal metal fixture 23C of base 21.

OIS resonant portion 31 is formed of a conductive material and resonates with the vibration of OIS piezoelectric elements 32 to convert the vibrational motion into a linear motion. OIS resonant portion 31 is formed, for example, by laser processing, etching processing, press working, or the like of a metal plate. In the present embodiment, OIS resonant portion 31 includes substantially rectangular body portion 311 sandwiched by OIS piezoelectric elements 32, two arm portions 312 extending in the X- or Y-direction from the upper and lower portions of body portion 311, protruding portion 313 extending in the X- or Y-direction from the central portion of body portion 311, and energization portion 314 extending from the central portion of body portion 311 on the opposite side of protruding portion 313.

Two arm portions 312 have symmetrical shapes whose free end portions make contact with OIS power transmission part 34 and symmetrically deform in resonance with the vibration of OIS piezoelectric elements 32. In the present embodiment, two arm portions 312 are formed such that the contact surfaces making contact with OIS plates 341 of OIS power transmission part 34 face inward and face each other.

Energization portion 314 of X-direction driving unit 30X is electrically connected to interconnection 17A of first stage 12, and energization portion 314 of Y-direction driving unit 30Y is electrically connected to terminal metal fixture 23C of base 21.

OIS piezoelectric elements 32 are bonded to body portion 311 of OIS resonant portion 31 in the thickness direction and are held in between by OIS electrode 33, so that these are electrically connected to one another. For example, one side of a power supply path is connected to OIS electrode 33, and the other side is connected to energization portion 314 of OIS resonant portion 31. A voltage is applied to OIS piezoelectric elements 32, and a vibration is thus generated.

OIS resonant portion 31 has at least two resonant frequencies, and deforms in behaviors different between the resonant frequencies. In other words, the entire shape of OIS resonant portion 31 is set such that OIS resonant portion 31 deforms in behaviors different between the two resonant frequencies. The different behaviors include a behavior causing OIS power transmission part 34 to move forward in the X- or Y-direction, and a behavior causing OIS power transmission part 34 to move backward in the X- or Y-direction.

OIS power transmission part 34 is a chucking guide extending in one direction, whose one end is connected to arm portions 312 of OIS resonant portion 31 and whose other end is connected to second stage 13. OIS power transmission part 34 includes stage connection member 342 connected to first stage 12 or second stage 13, and plate-shaped OIS plates 341 coupling together OIS ultrasonic motor USM1 (OIS resonant portion 31) and stage connection member 342.

Two OIS plates 341 are disposed to make contact respectively with two arm portions 312 of OIS resonant portion 31. Two OIS plates 341 are disposed substantially parallel to each other. The surfaces of OIS plates 341 on the sides where the OIS plates make contact with OIS resonant portion 31 are referred to as “first surfaces,” and the surfaces on the other sides are referred to as “second surfaces.” OIS plates 341 are disposed such that the second surfaces face each other.

One end portions 341b of OIS plates 341 (hereinafter referred to as “OIS motor contact portions 341b”) make sliding contact with the free end portions of arm portions 312 of OIS resonant portion 31. The other end portions of OIS plates 341 are inserted into and fixed to stage connection member 342. Portions of OIS plates 341 extending from OIS motor contact portions 341b toward the other end portions are referred to as “extension portions 341a.”

Stage connection member 342 is fixed to OIS chucking guide fixing portion 135 (see FIG. 10 and the like) of second stage 13. Stage connection member 342 has, for example, a structure that sandwiches the bases of extension portions 341a of OIS plates 341. Thus, it is possible to prevent OIS plates 341 from being displaced over time to come off. The reliability is thus improved.

The width between OIS motor contact portions 341b is set wider than the width between the free end portions of arm portions 312 of OIS resonant portion 31. In the present embodiment, stage connection member 342 includes spacing portion 342a and plate fixing portion 342b at a portion to which OIS plates 341 are connected. Plate fixing portion 342b is formed in a groove-like shape, in which the end portions of OIS plates 341 are inserted. By making the width of spacing portion 342a larger than the width of plate fixing portion 342b, two extension portions 341a are disposed away from each other toward OIS motor contact portions 341b, and also the width between OIS motor contact portions 341b increases. Thus, when OIS power transmission part 34 is attached between arm portions 312 of OIS resonant portion 31, extension portions 341a function as leaf springs, and a biasing force acts on arm portions 312 in the direction of pushing out arm portion 312. This biasing force allows OIS power transmission part 34 to be held between the free end portions of arm portions 312. Accordingly, the driving force from OIS resonant portion 31 is efficiently transmitted to OIS power transmission part 34.

OIS resonant portion 31 and OIS power transmission part 34 are only in contact with each other in a biased state; hence, it is possible to lengthen the movement stroke of OIS movable part 10 only by increasing the contact portions in the X- or Y-direction without enlarging the outer shape of optical-element driving device 1.

X-direction driving unit 30X is fixed to OIS movable part 10 (first stage 12) and is connected to second stage 13 via OIS power transmission part 34, and moves together with OIS movable part 10 during shake correction performed by Y-direction driving unit 30Y in the Y-direction. On the other hand, Y-direction driving unit 30Y is fixed to OIS fixing part 20 (base 21) and is connected to second stage 13 via OIS power transmission part 34, and is not affected by shake correction performed by X-direction driving unit 30X in the X-direction. That is, the movement of OIS movable part 10 by one of OIS driving units 30 is not hindered by the structure of the other one of OIS driving units 30. Therefore, it is possible to prevent rotation of OIS movable part 10 around the Z-axis, so as to allow OIS movable part 10 to move in the XY plane accurately.

Furthermore, damper material 72 is disposed between two extension portions 341a. For example, damper material 72 is disposed after OIS power transmission part 34 is connected between two arm portions 312 of OIS resonant portion 31. Damper material 72 is formed of a gel-like resin material having a viscosity and elasticity that allow the damper material to remain between two extension portions 341a and that do not impair the movement of OIS power transmission part 34. For example, a silicone material, a silicone-based vibration-damping material, or the like can be employed as damper material 72.

Extension portions 341a are plate-shaped portions, and are likely to vibrate with the resonance of OIS resonant portion 31. This vibration is transmitted through the air and is recognized as a driving sound. In the present embodiment, since damper material 72 is disposed between two extension portions 341a, the vibration at two extension portions 341a is efficiently attenuated in a short time, and aerial vibration caused by the vibration transmission from the opposing second surfaces are also suppressed. Therefore, the generation of the driving sound can be suppressed, and the noise reduction performance of optical-element driving device 1 is remarkably improved.

In addition, damper material 72 is disposed only on extension portions 341a of OIS plates 341, and is not disposed on OIS motor contact portions 341b. Thus, the influence of damper material 72 on a contact state (sliding state) of OIS motor contact portions 341b making contact with OIS resonant portion 31 can be suppressed. It is thus possible to obtain stable driving performance as in the case where damper material 72 is not disposed.

FIGS. 10 to 12 are exploded perspective views of OIS movable part 10. FIG. 11 illustrates OIS movable part 10 rotated 180° around the Z-axis from the state of FIG. 10. FIG. 12 is a lower perspective view illustrating OIS movable part 10 rotated 180° around the Z-axis from the state of FIG. 10. Note that, FIG. 11 illustrates a state where AF driving unit 14 and X-direction driving unit 30X are detached from first stage 12.

In the following, in a rectangle that is a planar shape of optical-element driving device 1, the side where AF driving unit 14 is disposed is referred to as “first side,” the side where X-direction driving unit 30X is disposed is referred to as “second side,” the side where Y-direction driving unit 30Y is disposed is referred to as “third side,” and the remaining one side is referred to as “fourth side.”

As illustrated in FIGS. 10 to 12, in the present embodiment, OIS movable part 10 includes AF movable part 11, first stage 12, second stage 13, AF driving unit 14, AF supporting part 15, and the like. For the movement in the Y-direction, entire OIS movable part 10 including first stage 12 and second stage 13 is a movable body, whereas for the movement in the X-direction, second stage 13 functions as OIS fixing part 20 and only the AF unit (AF movable part 11 and first stage 12) functions as OIS movable part 10. Further, first stage 12 functions as an AF fixing part for supporting AF movable part 11.

AF movable part 11 is a lens holder for holding lens part 2 (see FIG. 2), and moves in the optical-axis direction during focusing. AF movable part 11 is disposed to be spaced radially inward from first stage 12 (AF fixing part), and is supported via AF supporting part 15 while biased toward first stage 12.

AF movable part 11 is formed of, for example, polyarylate (PAR), a PAR alloy that is a mixture of multiple resin materials containing PAR, a liquid crystal polymer, or the like. AF movable part 11 includes cylindrical lens housing 111. Lens part 2 is fixed to the inner peripheral surface of lens housing 111, for example, adhesively.

AF movable part 11 includes, at the outer circumferential surface of lens housing 111, protruding portions 112A to 112D protruding radially outward and extending in the optical-axis direction. Protruding portions 112A to 112D protrude on the image formation side in the optical-axis direction beyond the lower surface of lens housing 111, and make contact with second base portions 213 of base 21, to restrict the movement of AF movable part 11 on the image formation side (lower side) in the optical-axis direction. In the present embodiment, protruding portions 112A to 112D make contact with second base portions 213 of base 21 in a reference state in which AF driving unit 14 is not driven.

Further, magnet housing 114 for housing magnet 16Z for Z position detection is disposed on the outer circumferential surface of lens housing 111. Magnet 16Z is disposed in magnet housing 114. Magnetic sensor 25Z for Z position detection is disposed on sensor board 22 at a position facing magnet 16Z in the optical-axis direction (see FIG. 5).

First stage 12 supports AF movable part 11 via AF supporting part 15. Second stage 13 is disposed on the image formation side of first stage 12 in the optical-axis direction via X-direction reference balls 42A to 42D. First stage 12 moves in the X- and Y-directions during shake correction, and second stage 13 moves only in the Y-direction during shake correction.

First stage 12 as seen in plan view in the optical-axis direction is a member having a substantially rectangular shape, and is formed of, for example, a liquid crystal polymer. First stage 12 has substantially circular opening 121 at a portion corresponding to AF movable part 11. Cutout portions 122 corresponding to protruding portions 112A to 112D and magnet housing 114 of AF movable part 11 are formed in opening 121. A portion of first stage 12 corresponding to X-direction driving unit 30X (the outer surface of the sidewall along the second side) is formed to be recessed radially inward such that X-direction driving unit 30X can be disposed without protruding radially outward (OIS motor fixing portion 124). Further, a portion of first stage 12 corresponding to Y-direction driving unit 30Y (the outer surface of the sidewall along the third side) is also similarly formed to be recessed radially inward.

First stage 12 includes, at the lower surface, X-direction reference ball holding portions 123A to 123D for holding X-direction reference balls 42A to 42D. X-direction reference ball holding portions 123A to 123D are formed to be recessed in a rectangular shape extending in the X-direction. X-direction reference ball holding portions 123A to 123D face X-direction reference ball holding portions 133A to 133D of second stage 13 in the Z-direction. X-direction reference ball holding portions 123A and 123B are formed substantially in a V-shape (tapered shape) in a section such that the groove width tapers toward the bottom side, and X-direction reference ball holding portions 123C and 123D are formed substantially in a U-shape.

In first stage 12, AF motor fixing portion 125 in which AF resonant portion 141, which is an active element of AF driving unit 14, and the like are disposed is formed on one sidewall along the X-direction (sidewall along the first side). AF motor fixing portion 125 includes an upper fixing plate (whose reference numeral is omitted) and lower fixing plate 125a, and AF resonant portion 141 is sandwiched between these plates. AF resonant portion 141 is inserted into, for example, an insertion hole (whose reference numeral is omitted) formed in the upper fixing plate and lower fixing plate 125a, and fixed by adhesion. The upper fixing plate is formed by a part of interconnection 17B, and AF resonant portion 141 is electrically connected to interconnection 17B.

Magnets 16X and 16Y for detecting the XY position are disposed on one of the sidewalls of first stage 12 extending along the Y-direction (the sidewall along the fourth side). For example, magnet 16X is magnetized in the X-direction, and magnet 16Y is magnetized in the Y-direction. Magnetic sensors 25X and 25Y for detecting the XY position are disposed on sensor board 22 at positions facing magnets 16X and 16Y in the optical-axis direction (see FIG. 5).

In addition, interconnections 17A and 17B are embedded in first stage 12, for example, by insert molding. Interconnections 17A and 17B are disposed, for example, along the first side and the second side. Interconnections 17A and 17B are exposed at the four corners of first stage 12, and one ends of OIS biasing members 50 are connected to this exposed portions. Power supply to X-direction driving unit 30X is performed via interconnection 17A, and power supply to AF driving unit 14 is performed via interconnection 17B.

Second stage 13 as seen in plan view in the optical-axis direction is a member having a substantially rectangular shape, and is formed of, for example, a liquid crystal polymer. Inner peripheral surface 131 of second stage 13 is formed correspondingly to the external shape of AF movable part 11. Portions of second stage 13 corresponding to X-direction driving unit 30X and Y-direction driving unit 30Y (the outer surfaces of the sidewalls along the second side and the third side) are formed to be recessed radially inward as in first stage 12.

Second stage 13 includes, at the lower surface, Y-direction reference ball holding portions 134A to 134C for housing Y-direction reference balls 41A to 41C. Y-direction reference ball holding portions 134A to 134C are formed to be recessed in the shape of a rectangle extending in the Y-direction. Y-direction reference ball holding portions 134A to 134C face Y-direction reference ball holding portions 217A to 217C of base 21 in the Z-direction. Y-direction reference ball holding portions 134A and 134B are formed substantially in a V-shape (tapered shape) in a section such that the groove width tapers toward the bottom side, and Y-direction reference ball holding portion 134C is formed substantially in a U-shape.

In addition, second stage 13 includes, at the upper surface, X-direction reference ball holding portions 133A to 133D for holding X-direction reference balls 42A to 42D. X-direction reference ball holding portions 133A to 133D are formed to be recessed in a rectangular shape extending in the X-direction. X-direction reference ball holding portions 133A to 133D face X-direction reference ball holding portions 123A to 123D of first stage 12 in the Z-direction. X-direction reference ball holding portions 133A to 133D are formed substantially in a V-shape (tapered shape) in a section such that the groove width tapers toward the bottom side. In the present embodiment, X-direction reference ball holding portions 133A and 133B are disposed in the side (second side) where X-direction driving unit 30X of second stage 13 is disposed, and X-direction reference ball holding portions 133C and 133D are disposed in the side (first side) where AF driving unit 14 is disposed. First stage 12 is supported at four points by X-direction reference balls 42A to 42D.

Y-direction reference balls 41A to 41C constituting OIS supporting part 40 are held at multiple contact points between Y-direction reference ball holding portions 217A to 217C of base 21 and Y-direction reference ball holding portions 134A to 134C of second stage 13. Therefore, Y-direction reference balls 41A to 41C roll stably in the Y-direction.

Further, X-direction reference balls 42A to 42D are held at multiple contact points between X-direction reference ball holding portions 133A to 133D of second stage 13 and X-direction reference ball holding portions 123A to 123D of first stage 12. Therefore, X-direction reference balls 42A to 42D roll stably in the X-direction.

AF supporting part 15 is a portion for supporting AF movable part 11 with respect to first stage 12 (AF fixing part). AF supporting part 15 includes first Z-direction reference balls 15A and second Z-direction reference balls 15B. First Z-direction reference balls 15A and second Z-direction reference balls 15B are rotatably interposed between AF movable part 11 and first stage 12. In the present embodiment, each set of first Z-direction reference balls 15A and second Z-direction reference balls 15B is composed of a plurality of balls (two balls in the present embodiment) disposed side by side in the Z-direction.

AF driving unit 14 is an actuator that move AF movable part 11 in the Z-direction. Like OIS driving units 30, AF driving unit 14 is composed of an ultrasonic motor. AF driving unit 14 is fixed to AF motor fixing portion 125 of first stage 12 such that arm portions 141b extend in the Z-direction. AF driving unit 14 includes AF ultrasonic motor USM2 and AF power transmission part 144.

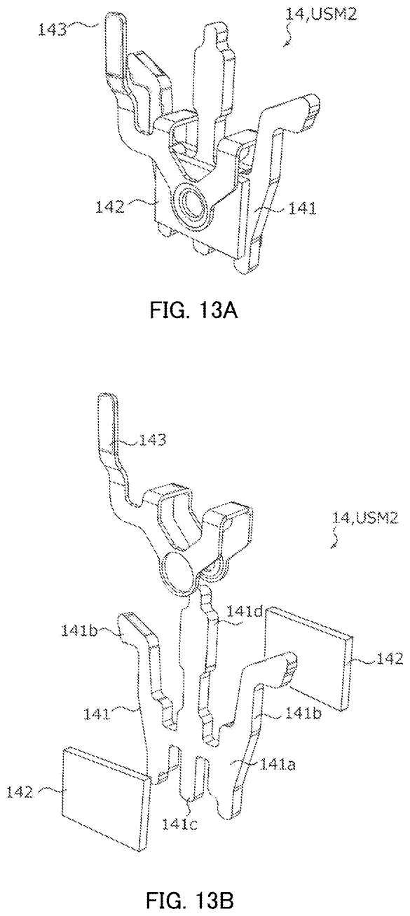

The configuration of AF driving unit 14 (excluding AF power transmission part 144) is illustrated in FIG. 13A and in 13B. FIG. 13A illustrates AF driving unit 14 whose members are assembled, and FIG. 13B illustrates AF driving unit 14 whose members are disassembled. The configuration of AF driving unit 14 is substantially the same as that of OIS driving units 30. The entire configuration of AF driving unit 14 including AF power transmission part 144 will be described later.

AF ultrasonic motor USM2 includes AF resonant portion 141, AF piezoelectric elements 142, and AF electrode 143. The driving force of AF ultrasonic motor USM2 is transmitted to AF movable part 11 via AF power transmission part 144. That is, in AF driving unit 14, AF resonant portion 141 is an active element, and AF power transmission part 144 is a passive element.

AF piezoelectric elements 142 are, for example, plate-shaped elements formed of a ceramic material, and generate a vibration under high-frequency voltage application. Two AF piezoelectric elements 142 are disposed to sandwich body portion 141a of AF resonant portion 141.

AF electrode 143 holds AF resonant portion 141 and AF piezoelectric elements 142 in between, and applies a voltage to AF piezoelectric elements 142.

AF resonant portion 141 is formed of a conductive material and resonates with the vibration of AF piezoelectric elements 142 to convert the vibrational motion into a linear motion. AF resonant portion 141 is formed, for example, by laser processing, etching processing, press working, or the like of a metal plate. In the present embodiment, AF resonant portion 141 includes substantially rectangular body portion 141a sandwiched between AF piezoelectric elements 142, two arm portions 141b extending in the Z-direction from body portion 141a, energization portion 141d extending in the Z-direction from the central portion of body portion 141a and electrically connected to the power supply path (interconnections 17B (upper fixing plate) of first stage 12), and stage fixing portion 141c extending from the central portion of body portion 141a toward the opposite side of energization portion 141d.

Two arm portions 141b have symmetrical shapes whose free end portions make contact with AF power transmission part 144, and symmetrically deform in resonance with the vibration of AF piezoelectric elements 142. In the present embodiment, two arm portions 141b are formed such that the surfaces of the arm portions making contact with AF plates 61 of AF power transmission part 144 face outward, and the free end portions are disposed to be sandwiched between AF plates 61.

AF piezoelectric elements 142 are bonded to body portion 141a of AF resonant portion 141 in the thickness direction and are held in between by AF electrode 143, so that these are electrically connected to one another. When energization portion 141d of AF resonant portion 141 and AF electrode 143 are connected to interconnection 17B of first stage 12, a voltage is applied to AF piezoelectric elements 142 and a vibration is thus generated.

Like OIS resonant portion 31, AF resonant portion 141 has at least two resonant frequencies, and deforms in behaviors different between the resonant frequencies. In other words, the entire shape of AF resonant portion 141 is set such that AF resonant portion 141 deforms in behaviors different between the two resonant frequencies.

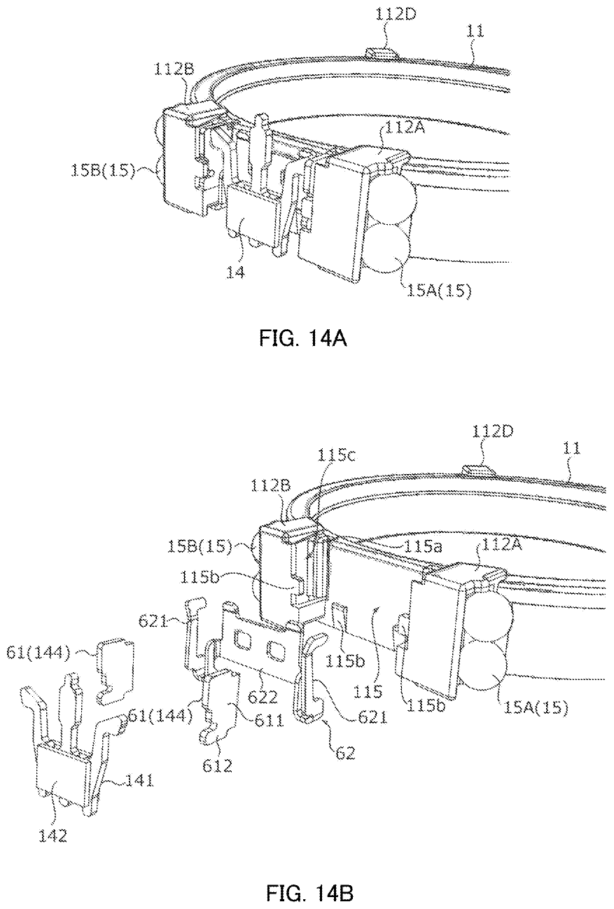

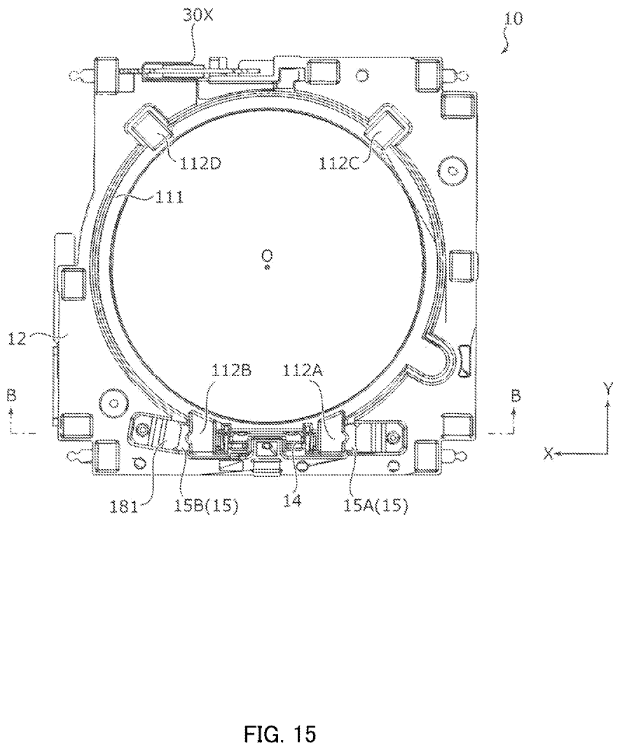

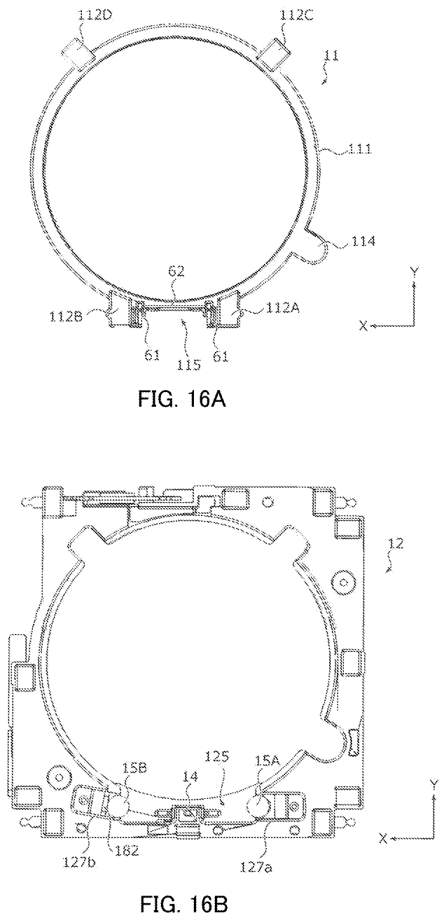

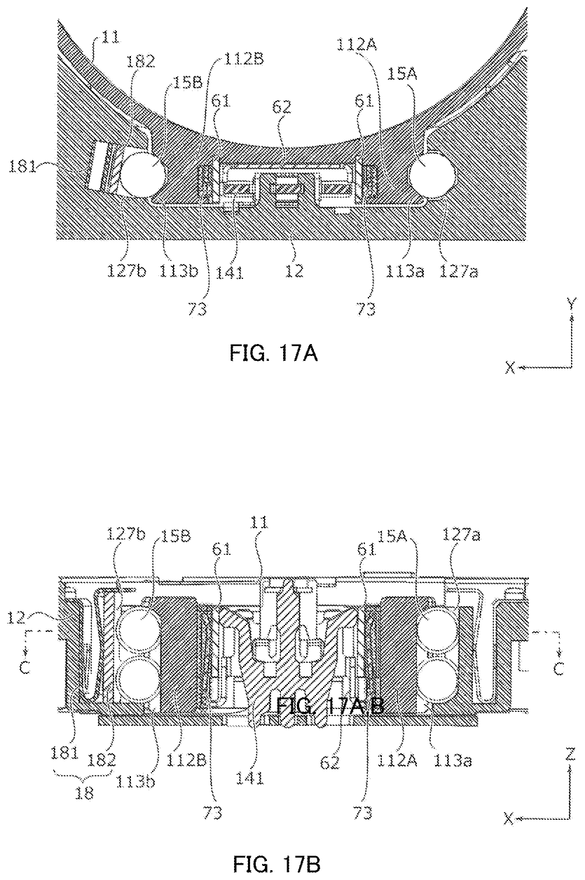

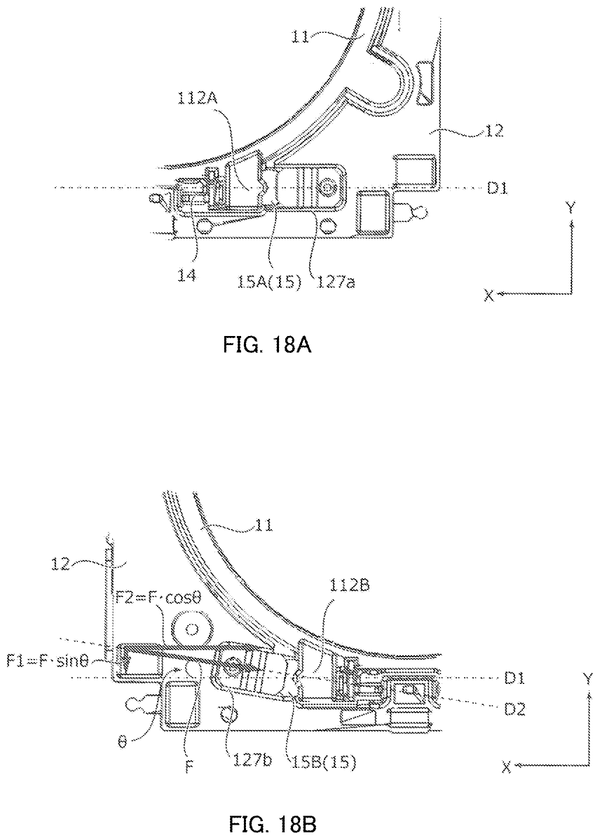

FIGS. 14A and 14B are diagrams illustrating a holding structure for holding AF driving unit 14. FIG. 14B is an exploded view of the holding structure for holding AF driving unit 14. FIG. 15 is a plan view of OIS movable part 10 as seen from the light reception side in the optical-axis direction. In FIG. 15, illustration of second stage 13 is omitted. FIGS. 16A and 16B are plan views of AF movable part 11 and first stage 12. FIGS. 17A and 17B are a cross-sectional view and a longitudinal sectional view of a peripheral portion of AF driving unit 14. FIG. 17A is a sectional view taken along line C-C and seen in the direction indicated by the arrows in FIG. 17B, and FIG. 17B is a sectional view taken along line B-B and seen in the direction indicated by the arrows in FIG. 15. FIGS. 18A and 18B are enlarged views illustrating the placement of AF supporting part 15.

As illustrated in FIGS. 14A, 14B, and the like, protruding portions 112A and 112B of AF movable part 11 are disposed to face each other in the X-direction, and form one space extending in the tangential direction (here, the X-direction) of lens housing 111.

Protruding portions 112A and 112B, together with first stage 12, hold Z-direction reference balls 15A and 15B being AF supporting part 15. First Z-direction reference ball holding portion 113a for accommodating first Z-direction reference balls 15A is formed in protruding portion 112A of protruding portions 112A and 112B. Second Z-direction reference ball holding portion 113b for accommodating second Z-direction reference balls 15B is formed in protruding portion 112B of protruding portions 112A and 112B. First Z-direction reference ball holding portion 113a and second Z-direction reference ball holding portion 113b are formed substantially in a V-shape (tapered shape) in a section such that the groove widths decrease toward the groove bottoms.

In AF movable part 11, a space formed by protruding portions 112A and 112B serves as driving-unit housing 115 in which AF driving unit 14 is disposed. Protruding portions 112A and 112B include plate housings 115c respectively on surfaces opposite first and second Z-direction reference ball holding portions 113a and 113b. AF power transmission part 144 and biasing member 62, which are passive elements of AF driving unit 14, are disposed in plate housings 115c.

AF power transmission part 144 is a chucking guide having a predetermined length in the Z-direction. In the present embodiment, AF power transmission part 144 includes two AF plates 61. Specifically, AF plates 61 are interposed between AF resonant portion 141 of AF driving unit 14 and biasing member 62. The power of AF resonant portion 141 is transmitted to AF movable part 11 via AF plates 61.

AF plates 61 are, for example, a hard plate-like member made of a metal material such as titanium copper, nickel copper, or stainless steel. AF plates 61 are disposed in AF movable part 11 along the moving direction such that first surfaces of the plates make contact with arm portions 141b of AF resonant portion 141, and are movable integrally with AF movable part 11. AF plates 61 are disposed in plate housings 115c of AF movable part 11 and are physically locked. Specifically, AF plates 61 are fixed to AF movable part 11, with guide insertion portions 611 being loosely fitted in guide grooves 115a formed in AF movable part 11 and fixation pieces 612 being disposed between the bottom surfaces of plate housings 115c and locking pieces 115b.

AF plates 61 only need to be fixed to AF movable part 11 to be capable of following the attachment state (individual difference in attachment position) of AF resonant portion 141. The plates do not have to be bonded, or may be bonded with an elastically deformable soft adhesive (for example, silicone rubber).

Further, damper material 73 is disposed between the second surfaces (the surfaces opposite the first surfaces) of AF plates 61 and opposing surfaces. Specifically, plate housings 115c in which AF plates 61 are disposed are filled with damper material 73 so as to be embedded in the damper material. Damper material 73 is formed, for example, in a state in which AF driving unit 14 is assembled. Damper material 72 is formed of a gel-like resin material having a viscosity and elasticity that allow the damper material to remain in plate housings 115c and that do not impair the biasing force of biasing member 62. For example, a silicone material, a silicone-based vibration-damping material, or the like can be employed as damper material 73.

AF plates 61 are plate-shaped portions, and are likely to vibrate with the resonance of AF resonant portion 141. This vibration is transmitted through the air and is recognized as a driving sound. In the present embodiment, since damper material 73 is disposed in plate housings 115c where AF plates 61 are disposed, the vibration of AF plates 61 is efficiently damped in a short time and the aerial vibration caused by the vibration transmission from the second surfaces is also suppressed. Therefore, the generation of the driving sound can be suppressed, and the noise reduction performance of optical-element driving device 1 is remarkably improved.

Biasing member 62 is a member for biasing AF plates 61 toward arm portions 141b of AF resonant portion 141, and includes two spring portions 621. Spring portions 621 are configured to press AF plates 61 against arm portions 141b with the same biasing forces. The biasing forces of spring portions 621 are not impaired by damper material 73.

Biasing member 62 is formed by, for example, sheet metal processing, and spring portions 621 are formed from leaf springs extending from coupling portion 622. Specifically, the leaf springs of spring portions 621 are formed to extend from a lower portion of coupling portion 622 toward the—side in the Z-direction, to be folded back outward in a hairpin shape, and to be inclined inward with respect to the Z-direction.

Biasing member 62 is fixed to AF movable part 11 by placing coupling portion 622 of biasing member 62 on spring placement portions 115d disposed on driving-unit housing 115 and disposing spring portions 621 in plate housings 115c. AF plates 61 are positioned at hairpin portions of biasing member 62, and are biased toward the inside (toward the arm portion 141b side) by spring portions 621. Biasing member 62 is not bonded to AF movable part 11 so as to be capable of following the attachment position of AF driving unit 14. That is, biasing member 62 is movable along an attachment surface of driving-unit housing 115, and is held at a position where the biasing loads of two spring portions 621 are uniform when the biasing member sandwiches AF driving unit 14 (AF resonant portion 141 and AF plates 61). Note that the configuration of biasing member 62 is one example and can be changed as appropriate. For example, an elastic body such as a coil spring or a hard rubber may be used.

In first stage 12, AF motor fixing portion 125 is formed by cutting out portions corresponding to protruding portions 112A and 112B of AF movable part 11 and corresponding to the space sandwiched between the protruding portions. Further, first Z-direction reference ball holding portion 127a and second Z-direction reference ball holding portion 127b are formed continuously to both sides of AF motor fixing portion 125.

First Z-direction reference ball holding portion 127a is formed along tangential direction D1 of lens housing 111 (see FIG. 18A). Further, the inner surface of first Z-direction reference ball holding portion 127a (the surface on the AF motor fixing portion 125 side) is formed to have a substantially V-shaped (tapered) sectional shape such that the groove width decreases toward the groove bottom.

Second Z-direction reference ball holding portion 127b is formed to be inclined with respect to tangential direction D1 of lens housing 111 (see FIG. 18B). Further, the inner surface of second Z-direction reference ball holding portion 127b (the surface on the AF motor fixing portion 125 side) is formed to have a substantially U-shaped section. Biasing part 18 (leaf spring 181 and spacer 182) for biasing AF movable part 11 via second Z-direction reference balls 15B is disposed together with second Z-direction reference balls 15B in second Z-direction reference ball holding portion 127b. Note that, FIG. 16B illustrates a state in which leaf spring 181 is removed.

Second Z-direction reference balls 15B are biased obliquely with respect to tangential direction D1 of lens housing 111 (see FIG. 18B). Thus, AF movable part 11 is pressed via second Z-direction reference balls 15B in the X-direction and the Y-direction, which are two directions orthogonal to each other, and is held in a stable attitude in the optical-axis-orthogonal plane. Letting the angle between tangential direction D1 and biasing direction D2 be 0 and the pressure by leaf spring 181 be F, the pressing force in the Y-direction is F1=F·sinθ, and the pressing force in the X-direction is F2=F·cosθ.

Here, angle θ formed by tangential direction D1 and biasing direction D2 is, for example, 0° to 45° (excluding 0°). Biasing direction D2 is set in balance with pressure F, for example, such that the rotation of AF movable part 11 about the optical axis is restricted. For example, when angle θ formed between biasing direction D2 and tangential direction D1 is increased, the pressing force in the Y-direction is increased. Accordingly, pressure F by leaf spring 181 can be reduced. However, increased angle θ causes disadvantages in terms of space, such as a need to increase the protrusion length of protruding portions 112A and 112B. On the contrary, it is advantageous in terms of space when angle θ formed between biasing direction D2 and tangential direction D1 is small. However, the pressing force in the Y-direction is reduced, and it is thus necessary to increase the pressure by leaf spring 181.

First Z-direction reference balls 15A are held between first Z-direction reference ball holding portions 113a and 127a of AF movable part 11 and first stage 12 in a rollable manner. Further, second Z-direction reference balls 15B are held between spacer 182 disposed in second Z-direction reference ball holding portion 127b of first stage 12 and second Z-direction reference ball holding portion 113b of AF movable part 11 in a rollable manner. AF movable part 11 is supported and held in a stable attitude by first stage 12 while biased via first Z-direction reference balls 15A and second Z-direction reference balls 15B.

First Z-direction reference balls 15A are sandwiched between AF movable part 11 and first stage 12, and are restricted from moving in the optical-axis-orthogonal direction orthogonal to the optical axis (the rotation of AF movable part 11). As a result, AF movable part 11 can be moved in a stable manner in the optical-axis direction.

Meanwhile, second Z-direction reference balls 15B are sandwiched between AF movable part 11 and first stage 12 via leaf spring 181 and spacer 182, and are allowed to move in the optical-axis-orthogonal direction orthogonal to the optical axis. With this configuration, it is possible to absorb the dimensional tolerances of AF movable part 11 and first stage 12, and the stability during movement of AF movable part 11 is improved.

Further, a portion of AF movable part 11 where AF driving unit 14 is disposed is sandwiched between first Z-direction reference balls 15A and second Z-direction reference balls 15B, and the pressure is applied to second Z-direction reference balls 15B, that is, AF movable part 11 is supported at one place with respect to first stage 12. Thus, it is easier to reduce the distance between, on one hand, the force point at which the driving force of AF driving unit 14 is applied, and, on the other hand, the rotational axis, and it is possible to reduce the moment to reduce the pressure. Further, by causing second Z-direction reference balls 15B to function as pressurization balls, it is possible to reduce the rolling resistance. Therefore, the driving efficiency of AF driving unit 14 is improved, and also becomes suitable for a lens driving device for a large diameter lens. In addition, in the condition of the same pressure, the tilt resistance is higher.

In addition, both first Z-direction reference balls 15A and second Z-direction reference balls 15B include two balls. In this case, the rolling resistances of first Z-direction reference balls 15A and second Z-direction reference balls 15B are smaller than in a case where each of the first and the second Z-direction reference balls includes three or more balls.

In optical-element driving device 1, when a voltage is applied to AF driving unit 14, AF piezoelectric elements 142 vibrate, and AF resonant portion 141 deforms in a behavior corresponding to the frequency. The driving force of AF driving unit 14 causes sliding of AF power transmission part 144 in the Z-direction. Accordingly, AF movable part 11 moves in the Z-direction, and focusing is performed. Since AF supporting part 15 is composed of balls, AF movable part 11 can move smoothly in the Z-direction. Moreover, AF driving unit 14 and AF power transmission part 144 are only in contact with each other in a biased state; hence, it is possible to lengthen the movement stroke of AF movable part 11 easily only by increasing a contact portion in the Z-direction without preventing height reduction for optical-element driving device 1.

In optical-element driving device 1, when a voltage is applied to OIS driving unit 30, OIS piezoelectric elements 32 vibrate, and OIS resonant portion 31 deforms in a behavior corresponding to the frequency. The driving force of OIS driving unit 30 causes sliding of OIS power transmission part 34 in the X- or Y-direction. Accordingly, OIS movable part 10 moves in the X- or Y-direction, and shake correction is performed. Since OIS supporting part 40 is composed of balls, OIS movable part 10 can move smoothly in the X- or Y-direction.

Specifically, when X-direction driving unit 30X is driven and OIS power transmission part 34 moves in the X-direction, power is transmitted to second stage 13 from first stage 12 in which X-direction driving unit 30X is disposed. At this time, balls 41 sandwiched between second stage 13 and base 21 are incapable of rolling in the X-direction, and the position of second stage 13 with respect to base 21 in the X-direction is maintained. On the other hand, balls 42 sandwiched between first stage 12 and second stage 13 are capable of rolling in the X-direction, first stage 12 moves with respect to second stage 13 in the X-direction. That is, second stage 13 serves as a component of OIS fixing part 20, and first stage 12 serves as components of OIS movable part 10.

Further, when Y-direction driving unit 30Y is driven and OIS power transmission part 34 moves in the Y-direction, power is transmitted to second stage 13 from base 21 where Y-direction driving unit 30Y is disposed. At this time, balls 42 sandwiched between first stage 12 and second stage 13 are incapable of rolling in the Y-direction, and the position of first stage 12 with respect to the second stage in the Y-direction is maintained. On the other hand, balls 41 sandwiched between second stage 13 and base 21 are capable of rolling in the Y-direction, second stage 13 moves with respect to base 21 in the Y-direction. First stage 12 also moves in the Y-direction following second stage 13. That is, base 21 serves as a component of OIS fixing part 20, and the AF unit including first stage 12 and second stage 13 serves as a component of OIS movable part 10.

As described above, OIS movable part 10 moves in the XY plane, and shake correction is performed. Specifically, an energization voltage to OIS driving units 30X and 30Y is controlled based on a detection signal indicative of an angular shake from a shake detection part (for example, a gyro sensor (not illustrated)) such that the angular shake of camera module A is canceled. In this case, it is possible to accurately control the translational movement of OIS movable part 10 by feeding back the detection result of the XY position detecting part composed of magnets 16X and 16Y and magnetic sensors 25X and 25Y.

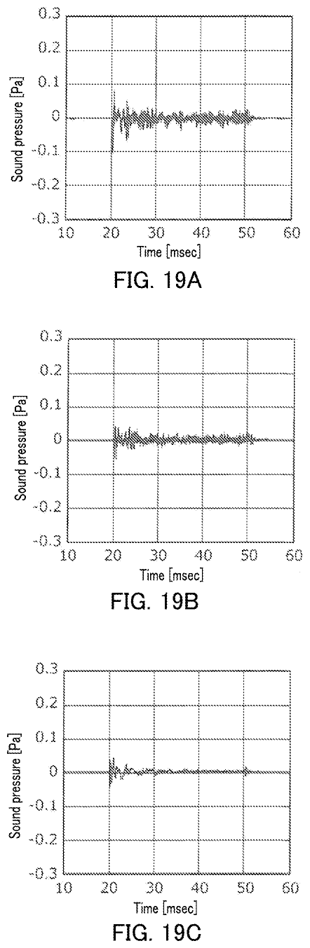

FIGS. 19A to 19C are diagrams illustrating driving sound properties of optical-element driving device 1 measured after OIS driving unit 30 is driven for a predetermined period (for example, 30 msec).

FIG. 19A illustrates a case where damper materials 71 to 73 are not disposed, FIG. 19B illustrates a case where damper material 71 is disposed only on and/or in OIS biasing members 50, and FIG. 19C illustrates a case where damper materials 71 and 72 are disposed on and/or in OIS biasing members 50 and OIS power transmission parts 34.

A difference between FIGS. 19A and 19B represents a noise reduction effect by damper material 71, and a difference between FIGS. 19B and 19C represents a noise reduction effect by damper material 72. That is, it is shown that damper material 71 disposed on and/or in OIS biasing members 50 attenuates the sound pressure level of the driving sound drastically, and reduces the reverberation sound. When damper material 72 is disposed on OIS power transmission part 34, the same noise reduction effect is obtained. Although a case where damper material 73 is disposed in AF power transmission part 144 is not illustrated in the figures, a similar noise reduction effect can be obtained.

As is understood, optical-element driving device 1 according to the present embodiment includes: a fixing part; a movable part disposed apart from the fixing part; a supporting part configured to support the movable part with respect to the fixing part; and a driving unit including an ultrasonic motor configured to convert a vibrational motion into a linear motion, and a power transmission part configured to transmit a driving force of the ultrasonic motor to the movable part, the driving unit being configured to move the movable part with respect to the fixing part. The power transmission part includes a plate making contact with a resonant portion of the ultrasonic motor, and a damper material is disposed on a second surface side of the plate that is opposite a first surface of the plate that makes contact with the resonant portion.

That is, optical-element driving device 1 includes OIS fixing part 20 (first fixing part), OIS movable part 10 (first movable part) disposed apart from OIS fixing part 20 in the optical-axis direction, OIS supporting part 40 (supporting part) configured to support OIS movable part 10 with respect to OIS fixing part 20, OIS driving unit 30 (first driving unit) including OIS ultrasonic motor USM1 and OIS power transmission part 34 and being configured to move OIS movable part 10 with respect to OIS fixing part 20 in the optical-axis-orthogonal plane orthogonal to the optical-axis direction. OIS power transmission part 34 includes OIS plates 341 making contact with OIS resonant portion 31 of OIS ultrasonic motor USM1, and damper material 72 is disposed on the second surface side of OIS plates 341 that is opposite the first surfaces of OIS plates 341 that make contact with OIS resonant portion 31.

Specifically, OIS resonant portion 31 includes two arm portions 312 formed such that the contact surfaces making contact with OIS plates 341 face each other, two OIS plates 341 are disposed to make contact respectively with two arm portions 312, and damper material 72 is disposed between two OIS plates 341.

Further, optical-element driving device 1 includes first stage 12 (second fixing part), AF movable part 11 (second movable part) disposed to be spaced apart inwardly from first stage 12, AF supporting part 15 (supporting part) configured to support AF movable part 11 with respect to first stage 12, and AF driving unit 14 (second driving unit) including AF ultrasonic motor USM2 and AF power transmission part 144 and being configured to move AF movable part 11 with respect to first stage 12 in the optical-axis direction. AF power transmission part 144 includes AF plates 61 making contact with AF resonant portion 141 of AF ultrasonic motor USM2, and damper material 73 is disposed between, on one hand, the second surfaces of AF plates 61 that are opposite the first surfaces of AF plates 61 that make contact with AF resonant portion 141 and, on the other hand, opposing surfaces facing the second surfaces.

Specifically, the AF resonant portion includes two arm portions 141b formed such that the contact surfaces making contact with AF plates 61 face away from each other, two AF plates 61 are disposed to make contact respectively with two arm portions 141b, and damper material 73 is disposed between each of two AF plates 61 and plate housing 115c in which AF plate 61 is disposed.

According to optical-element driving device 1, since OIS driving unit 30 and AF driving unit 14 are composed of an ultrasonic motor, it is possible to reduce an influence of external magnetism, and to reduce the size and height. Even when camera modules A having optical-element driving device 1 are disposed close to each other as in smartphone M, no magnetic influence is caused. Thus, the optical-element driving device is extremely suitable for use in a dual camera.

Further, according to optical-element driving device 1, vibration of OIS plates 341 accompanying the drive of OIS ultrasonic motor USM1 is efficiently damped by damper material 72, and the aerial vibration by the vibration transmission from OIS plates 341 is reduced. In addition, vibration of AF plates 61 accompanying the drive of AF ultrasonic motor USM2 is efficiently damped by damper material 73, and the aerial vibration by the vibration transmission from AF plates 61 is reduced. Therefore, the noise reduction performance of optical-element driving device 1 is remarkably improved.

While the invention made by the present inventors has been specifically described based on the preferred embodiment, it is not intended to limit the present invention to the above-mentioned preferred embodiment, but the present invention may be further modified within the scope and spirit of the invention defined by the appended claims.

For example, while smartphone M serving as a camera-equipped mobile terminal has been described in the embodiment as one example of the camera-mounted device including camera module A, the present invention is applicable to a camera-mounted device including a camera module and an image processing part that processes image information obtained by the camera module. The camera-mounted device encompasses an information apparatus and a transporting apparatus. Examples of the information apparatus include a camera-mounted mobile phone, a note-type personal computer, a tablet terminal, a mobile game machine, a web camera, and a camera-mounted in-vehicle device (for example, a rear-view monitor device or a drive recorder device). In addition, examples of the transporting apparatus include an automobile.

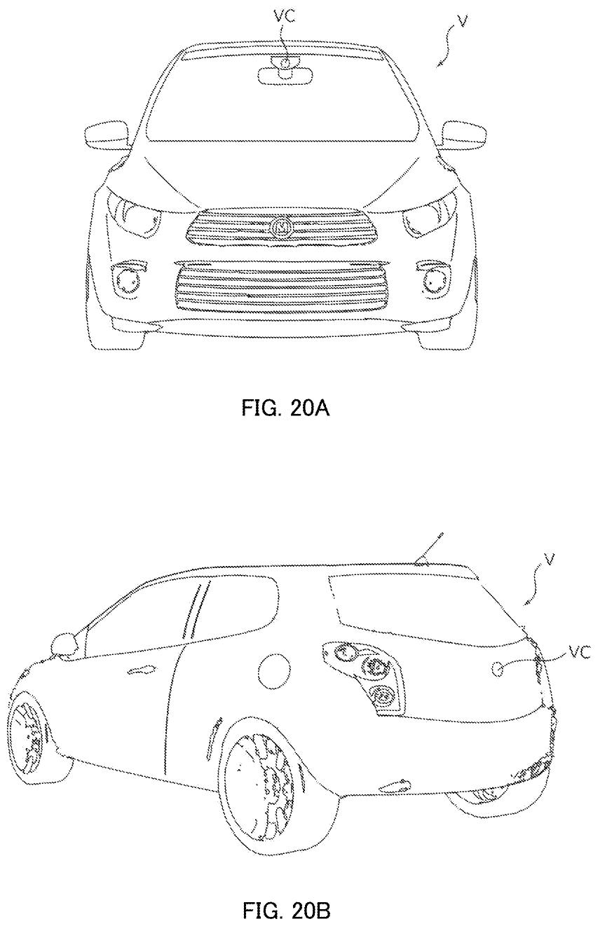

FIGS. 20A and 20B illustrate automobile V serving as the camera-mounted device in which in-vehicle camera module VC (Vehicle Camera) is mounted. FIG. 20A is a front view of automobile V and FIG. 20B is a rear perspective view of automobile V. In automobile V, camera module A described in the embodiment is mounted as in-vehicle camera module VC.

As illustrated in FIGS. 20A and 20B, in-vehicle camera module VC may, for example, be attached to the windshield so as to face forward, or to the rear gate so as to face backward. In-vehicle camera module VC is used for rear monitoring, drive recording, collision avoidance control, automatic drive control, and the like.

Although damper materials 72 and 73 are disposed respectively on and/or in OIS power transmission part 34 and AF power transmission part 144 in the embodiment, the damper materials may be disposed on and/or in one of OIS power transmission part 34 and AF power transmission part 144.

Further, the present invention is applicable not only to optical-element driving devices including driving units for auto-focusing and for shake correction, but also to optical-element driving devices configured to move a movable part with respect to a fixing part using an ultrasonic motor. For example, a damper material may be disposed on and/or in a driving unit for zooming in/out.

In addition, although the embodiment has been described in relation to optical-element driving device 1 that drives lens part 2 as an optical element, the optical element to be driven may be an optical element other than a lens, such as a mirror or a prism.

The embodiment disclosed herein is merely an exemplification in every respect and should not be considered as limitative. The scope of the present invention is specified by the claims, not by the above-mentioned description. The scope of the present invention is intended to include all modifications in so far as they are within the scope of the appended claims or the equivalents thereof.

The disclosure of U.S. provisional Patent Application No. 63/109,385, filed on Nov. 4, 2020, including the specification, drawings and abstract is incorporated herein by reference in its entirety.

### REFERENCE SIGNS LIST

1 Optical-element driving device
10 OIS movable part (first movable part)
12 First stage (second fixing part)
13 Second stage
14 AF driving unit (second driving unit)
141 AF resonant portion (active element)
142 AF piezoelectric element
143 AF electrode
144 AF power transmission part (passive element)
15 AF supporting part (second supporting part)
15A First Z-direction reference ball
15B Second Z-direction reference ball
20 OIS fixing part (first fixing part)
21 Base
30 OIS driving unit
31 OIS resonant portion (active element)
32 OIS piezoelectric element
33 OIS electrode
34 OIS power transmission part (passive element)
341 OIS plate
40 OIS supporting part (first supporting part)
50 OIS biasing member
61 AF plate
62 Biasing member
71 to 73 Damper material
A Camera module
M Smartphone (camera-mounted device)

1. An optical-element driving device, comprising:
a fixing part;
a movable part disposed apart from the fixing part;
a supporting part configured to support the movable part with respect to the fixing part; and
a driving unit including an ultrasonic motor configured to convert a vibrational motion into a linear motion, and a power transmission part configured to transmit a driving force of the ultrasonic motor to the movable part, the driving unit being configured to move the movable part with respect to the fixing part, wherein:
the power transmission part includes a plate making contact with a resonant portion of the ultrasonic motor, and
a damper material is disposed on a second surface side of the plate that is opposite a first surface of the plate that makes contact with the resonant portion.

2. The optical-element driving device according to claim 1, wherein:
the fixing part includes a first fixing part,
the movable part includes a first movable part disposed apart from the first fixing part in an optical-axis direction,
the driving unit includes a first driving unit configured to move the first movable part with respect to the first fixing part in an optical-axis-orthogonal plane orthogonal to the optical-axis direction,
the resonant portion includes two arms formed such that contact surfaces making contact with the plate face each other,
the plate comprises two plates that are disposed to make contact respectively with the two arms, and
the damper material is disposed between the two plates.

3. The optical-element driving device according to claim 1, wherein:
the fixing part includes a second fixing part,
the movable part includes a second movable part disposed to be spaced apart inwardly from the second fixing part,
the driving unit includes a second driving unit configured to move the second movable part with respect to the second fixing part in an optical-axis direction,
a resonant portion includes two arms formed such that contact surfaces making contact with the plate face away from each other,
the plate comprises two plates that are disposed to make contact respectively with the two arms, and
the damper material is disposed between each of the two plates and a plate housing in which the plate is disposed.

4. The optical-element driving device according to claim 2, wherein:
the plate includes a motor contact portion making contact with the resonant portion, and an extension portion extending from the motor contact portion, and
the damper material is disposed on the extension portion.

5. A camera module, comprising:
an optical-element driving device according to claim 1;
an optical element to be attached to the movable part; and
an image capturing part configured to capture a subject image imaged by the optical element.

6. A camera-mounted device that is an information apparatus or a transporting apparatus, the camera-mounted device comprising:
an camera module according to claim 5; and
an image processing part configured to process image information obtained by the camera module.
